(19) United States
(12) Patent Application Publication
(10) Pub. No.: US 2025/0089106 A1
(43) Pub. Date: Mar. 13, 2025

(54) METHODS AND SYSTEMS FOR ESTABLISHING IP MULTIMEDIA SUBSYSTEM (IMS) SESSIONS

(71) Applicant: SAMSUNG ELECTRONICS CO, LTD., Suwon-si (KR)

(72) Inventors: Srinivas CHINTHALAPUDI, Bangalore (IN); Jaya Prakash SIVAPURAM, Bangalore (IN); Varun Bharadwaj SANTHEBENUR VASUDEVAMURTHY, Bangalore (IN); Sandeep C M, Bangalore (IN)

(73) Assignee: SAMSUNG ELECTRONICS CO, LTD., Suwon-si (KR)

(21) Appl. No.: 18/827,075

(22) Filed: Sep. 6, 2024

(30) Foreign Application Priority Data
Sep. 8, 2023 (IN) 202341060584
Sep. 3, 2024 (IN) 202341060584

(51) Int. Cl. H04W 76/10; H04L 65/1016; H04L 65/1045; H04W 24/08

(52) U.S. Cl. CPC H04W 76/10; H04L 65/1016; H04L 65/1045; H04W 24/08

(57) ABSTRACT

A method of establishing Internet protocol (IP) multimedia subsystem (IMS) sessions at a mobile originating (MO) device includes establishing, with a mobile terminating (MT) device, a first IMS session over a first network, determining that the MO device failed to receive a response from the first network within a predefined time period after the establishing of the first IMS session, establishing, with the MT device, a second IMS session over a second network, based on the determining that the MO device failed to receive the response from the first network, terminating, based on a content of a dedicated bearer, at least one of the first IMS session or the second IMS session, and communicating with the MT device over a remaining IMS session from the at least one of the first IMS session or the second IMS session.

### CROSS-REFERENCE TO RELATED APPLICATIONS

This application claims priority under 35 U.S.C. § 119 to Indian Complete Patent Application No. 202341060584, filed on Sep. 3, 2024, and Indian Provisional Patent Application No. 202341060584, filed on Sep. 8, 2023, in the Indian Patent Office, the disclosures of which are incorporated by reference herein in their entireties.

### BACKGROUND

### 1. Field

The present disclosure relates generally to wireless networks, and more particularly, to methods and systems for establishing Internet protocol (IP) multimedia subsystem (IMS) sessions.

### 2. Description of Related Art

Recently, several broadband wireless technologies have been developed to meet a growing number of broadband subscribers by providing better applications and services. For example, a second-generation (2G) wireless communication system was developed to provide voice services while attempting to ensure the mobility of users. Similarly, a third-generation (3G) wireless communication system was developed to support voice services as well as data services. Further, a fourth-generation (4G) wireless communication system has been developed to provide high-speed data service. However, 4G wireless communication systems may suffer from a lack of resources when attempting to meet a growing demand for high-speed data services. To that end, a fifth-generation (5G) wireless communication system, which provides ultra-reliability and supports low-latency applications. Further, voice over new radio (VoNR) technology enables voice calls to be made over 5G wireless networks using new radio (NR) technology, which is part of the 5G wireless communication system.

Initially, NR devices such as, but not limited to, a user equipment (UE), may need to be flexible an reuse a related 4G internet protocol (IP) multimedia subsystem (IMS) architecture to potentially support a plurality of telephony features. For example, some related 5G wireless networks may deploy support for VoNR gradually. However, when calls are dialed in poor 4G/5G border areas, there may be a possibility of call failures due to race conditions. For example, a mobile originating (MO) device (e.g., a first UE) may attempt to place a call to a mobile terminated (MT) device (e.g., a second UE) on a Long Term Evolution (LTE) and/or a 4G network and may attempt to handover to the NR network. However, due to possible race conditions, there may be a significant likelihood that the first UE may retry to place the call over the LTE/4G network when the call has failed over NR. Further, in the case of a legacy system (e.g., LTE, 3G, 2G, or the like), the call may be retried over circuit switching (CS) when the call fails over the LTE. That is, the core network (e.g., CS or packet switching (PS)) involved in placing the call may be different in legacy radio access technology (RAT) and may not have the race conditions that may occur when the first UE moves to LTE. However, in the case of NR and/or LTE, the core network involved may be the same (e.g., PS), and as such, both networks may use IMS as the backend for supporting the calls. Therefore, a retry mechanism may be required to be in sync, in order to potentially avoid network collisions that may result in dropped calls.

When a voice and/or video call is tried over NR (e.g., VoNR) and no response is received from the network after an invite timer expires, the call may be retried over the LTE network (e.g., voice over LTE (VoLTE)) by reselecting to the LTE network. That is, the VoNR call may fail due to multiple reasons such as the UE may have failed in sending the invite message or the invite may have reached the IMS core over the NR, but the UE did not receive a response due to poor network conditions. Alternatively or additionally, the VoNR call may fail, even when the invite may have reached the IMS core over the NR, due to the network having failed to allocate a dedicated bearer due to a race condition. As another example, the VoNR call may fail due to the NR to LTE redirection/handover having failed during call setup time. As another example, the VoNR call may fail due to a state mismatch between the MO device and the MT device due to a message drop.

FIG. 1 illustrates a signal flow diagram 100 of an evolved packet system (EPS) fallback success of a related wireless network. As shown in FIG. 1, a first UE UE1 may be in communication with a second UE UE2. At operation 102, the first UE UE1 may transmit an invite message (e.g., INVITE (PANI: NR CELL)) for initiating an IMS session with the second UE UE2 to a network NR. At operation 104, the invite message may be transmitted from the network NR to the second UE UE2. At operation 106, the second UE UE2 may transmit a first invite response (e.g., INVITE 1XX) to the network NR. At operation 108, the network NR may forward the received first invite response INVITE 1XX to the first UE UE1, which may cause the first UE UE1 to initiate an EPS fall back process from the network NR. At operation 110, the first UE UE1 may receive a handover/redirection from network NR to perform a handover to LTE. At operation 112, the first UE UE1 may transmit a tracking area update (TAU) request (REQ) to network LTE, which may connect the first UE UE1 to the network LTE and may establish a dedicated bearer. At operation 114, the second UE UE2 may transmit a second invite response (e.g., INVITE 2XX) to network NR. At operation 116, the network NR may forward the second invite response INVITE 2XX to the first UE UE1. At operation 118, the first UE UE1 may transmit an acknowledgment (ACK) to the network NR, which may complete the EPS fallback process.

FIG. 2 illustrates an example scenario associated with an IMS core network using a call flow 200, in a related wireless network. As shown in FIG. 2, the call flow 200 may start based on a determination that the first UE UE1 has detected a poor signal condition. At operation 202, the first UE UE1 may transmit an invite message (e.g., INVITE (PANI: NR CELL)) requesting to initiate an IMS session with the second UE UE2 over the network NR. However, the invite message may not reach NR network, due to, for example, the poor signal conditions. In such an example, a transmission control protocol (TCP) layer of the first UE UE1 may continue retransmitting the invite message to the network NR. Further, the first UE UE1 may also attempt to move to the network LTE. At operation 204, the first UE UE1 may transmit a TAU request (REQ) to the network LTE. At operation 206, the network LTE may transmit an IMS radio bearer configured to the first UE UE1. In addition, the TCP/IP layer of the first UE UE1 may transmit an invite message to the network LTE. At operation 208, the first UE UE1 may transmit the invite message (e.g., INVITE (PANI: NR CELL)) to the network LTE. However, since the invite message may be using the old NR cell identifier, the network LTE may reject invite request, which may lead to a call drop.

FIGS. 3A and 3B illustrate an example problem scenario of the IMS core network using a call flow 300, in a related wireless network. The call flow 300 may start based on a determination that the first UE UE1 detected a poor signal condition. At operation 302, the first UE UE1 may transmit a first invite message along with a session identification (ID) (e.g., INVITE (PANI: NR CELL, CallID session 1) requesting to initiate a first IMS session with the second UE UE2 through the network NR. At operation 304, the network NR may attempt to transmit a first invite response (e.g., INVITE 1XX (CallID session 1)) to the first UE UE1, however, the first invite response may fail to arrive and/or the first UE UE1 may fail to receive the first invite response. At operation 306, the network NR may transmit the received first invite message along with the session ID to the second UE UE2. At operation 308, the second UE UE2 may transmit the first invite response (e.g., INVITE 1XX (CallID session 1)) to the network NR. At operation 310, the network NR may attempt to transmit the first invite response to the first UE UE1, however, the first invite response may fail to arrive and/or the first UE UE1 may fail to receive the first invite response. Subsequently, the second UE UE2 may fall back to network LTE. The second UE UE2 may also stay connected to the network NR. That is, the first invite response may have reached the network (e.g., the network NR), but the first invite response may not have been received by the first UE UE1. Subsequently, the first UE UE1 may move to the network LTE. Accordingly, at operation 312, a TAU procedure may be interchangeably shared between the first UE UE1 and the network LTE. At operation 314, the network LTE may transmit a configured IMS radio bearer to the first UE UE1. At operation 316, the first invite session timer may expire. Accordingly, the first UE UE1 may clear the first IMS session and may transmit a new invite message to the network LTE for a VoLTE retry. At operation 318, the first UE UE1 may transmit a second invite message along with information about the LTE cell and second session identification (e.g., INVITE (PANI: NR CELL, CallID session 2)) to the network LTE. At operation 320, the network LTE may forward the second invite message and the CallID session 2 to the second UE UE2. At operation 322, the network LTE may transmit a second invite response with CallID session 2 (e.g., INVITE 1XX (CallID session 2)) to the first UE UE1. At operation 324, the network LTE may again transmit the first invite response to the first UE UE1. At operation 326, the second UE UE2 may transmit the second invite response to the network LTE. However, as the first UE UE1 may have already cleared the first session, the first UE UE1 may transmit a cancel command upon receiving the first invite response from the network LTE. Furthermore, since the second UE UE2 may still be trying to establish the first session, the second UE UE2 may reject the second invite message with a busy status, for example. Accordingly, at operation 328, the second UE UE2 may transmit a cancel invite message for session 2 (e.g., INVITE 4XX (CallID: Session 2)). At operation 330, the network LTE may transmit the cancel invite message to the first UE UE1. At operation 332, the first UE UE1 may transmit a cancel command for session 1 (e.g., INVITE 4XX (CallID: Session 1)) to the network LTE, which may be forwarded to the second UE UE2 at operation 334. Accordingly, at operations 336 and 338, cancel commands for session 1 may be transmitted from the second UE UE2 to the network LTE. Consequently, because of this crossover, both invites to the sessions (e.g., session 1 and session 2) may fail, and a call drop may occur.

Accordingly, there exists a need for further improvements in wireless communications, as the need for growing numbers of broadband subscribers and the need to provide better applications and services may be constrained by race conditions and the like that may result in dropped calls. Improvements are presented herein. These improvements may also be applicable to other communication technologies and the telecommunication standards that employ these technologies.

### SUMMARY

This summary is provided to introduce a selection of concepts in a simplified format that are further described in the detailed description of the present disclosure. This summary is not intended to identify key or essential concepts of the present disclosure, nor is this summary intended for determining the scope of the disclosure.

According to an aspect of the present disclosure, a method of establishing internet protocol (IP) multimedia subsystem (IMS) sessions at a mobile originating (MO) device, includes establishing, with a mobile terminating (MT) device, a first IMS session over a first network, determining that the MO device failed to receive a response from the first network within a predefined time period after the establishing of the first IMS session, establishing, with the MT device, a second IMS session over a second network, based on the determining that the MO device failed to receive the response from the first network, terminating, based on a content of a dedicated bearer, at least one of the first IMS session or the second IMS session, and communicating with the MT device over a remaining IMS session from the at least one of the first IMS session or the second IMS session. The first IMS session being configured to perform first communications between the MO device and the MT device. The second IMS session being configured to perform second communications between the MO device and the MT device.

According to an aspect of the present disclosure, a method of establishing IMS sessions at a network device, includes receiving, from a MO device, an invite message requesting to establish an IMS session with a MT device, determining whether the invite is received on a current radio access network (RAN) or a new RAN by comparing a P-access network information header of the invite message with current voice domain preference RAN information of the network device, rejecting the invite message based on determining that the invite is received on the new RAN, generating one or more recommendations for the MO device to establish the IMS session via the current RAN, and transmitting, to the MO device, the one or more recommendations.

According to an aspect of the present disclosure, a system for establishing IMS sessions at a MO device, includes a memory storing instructions, a transceiver, and one or more processors communicatively coupled to the memory and the transceiver. The one or more processors are configured to execute the instructions to establish a first IMS session over a first network, determine that the MO device failed to receive a response from the first network within a predefined time-period after the establishing of the first IMS session, establish a second IMS session over a second network based on the determining that the MO device failed to receive the response from the first network, terminate at least one of the first IMS session or the second IMS session based on a content of a dedicated bearer, and perform communications between the MO device and the MT device over a remaining IMS session from the at least one of the first IMS session or the second IMS session. The first IMS session being configured to perform first communications between the MO device and the MT device. The second IMS session being configured to perform second communications between the MO device and the MT device.

According to an aspect of the present disclosure, a system for establishing IMS sessions at a network device, includes a memory storing instructions, a transceiver, and a one or more processors communicatively coupled to the memory and the transceiver. The one or more processors are configured to execute the instructions to receive, from a MO device via the transceiver, an invite message requesting to establish an IMS session with a MT device, determine whether the invite is received on a current RAN or a new RAN by comparing a P-access network information header of the invite message with current voice domain preference RAN information of the network device, reject the invite message based on a determination that the invite is received on the new RAN, generate one or more recommendations for the MO device to establish the IMS session via the current RAN, and transmit, to the MO device via the transceiver, the one or more recommendations.

To further clarify the advantages and features of the present disclosure, a more particular description is rendered by reference to specific embodiments thereof, which may be illustrated in the appended drawings. It is to be appreciated that these drawings may depict only example embodiments of the disclosure and are therefore not to be considered limiting in scope. The present disclosure is described and explained with additional specificity and detail with the accompanying drawings.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 illustrates a signal flow diagram of an evolved packet system (EPS) fallback success, according to a related wireless network;

FIG. 2 illustrates an example problem scenario associated with IMS Core network using a call flow, according to a related wireless network;

FIGS. 3A and 3B illustrate an example problem scenario of the IMS core network using a call flow, according to a related wireless network;

FIG. 4 illustrates a block diagram of a system for establishing internet protocol (IP) Multimedia Subsystem (IMS) sessions by a mobile originating device, according to an embodiment;

FIG. 5 illustrates a method for establishing IMS sessions by a mobile originating device, according to an embodiment;

FIGS. 6A and 6B illustrate a signal flow diagram for establishing IMS sessions by a mobile originating device, according to an embodiment;

FIG. 7 illustrates a block diagram of a system for IMS sessions by a network, according to an embodiment;

FIG. 8 illustrates a method for establishing IMS sessions by a network, according to an embodiment; and

FIG. 9 illustrates a signal flow diagram for establishing IMS sessions, according to an embodiment.

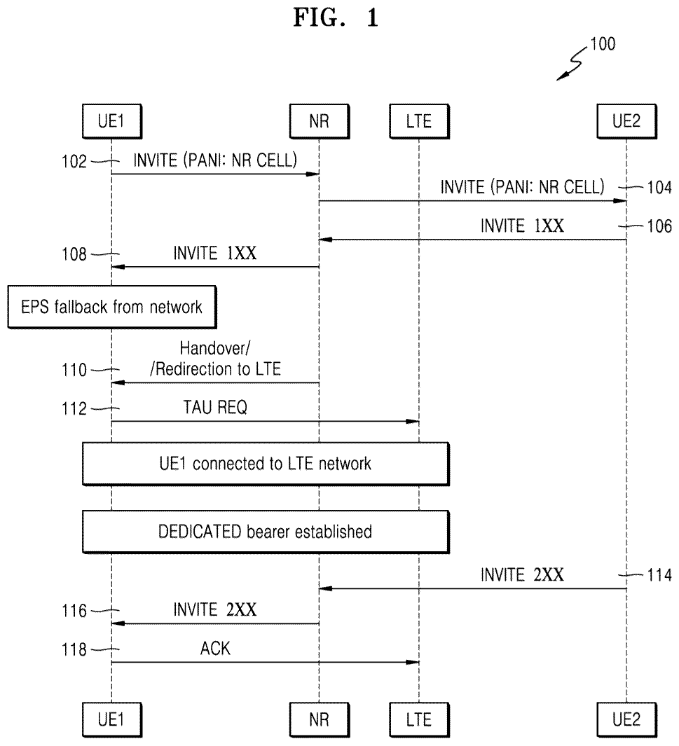

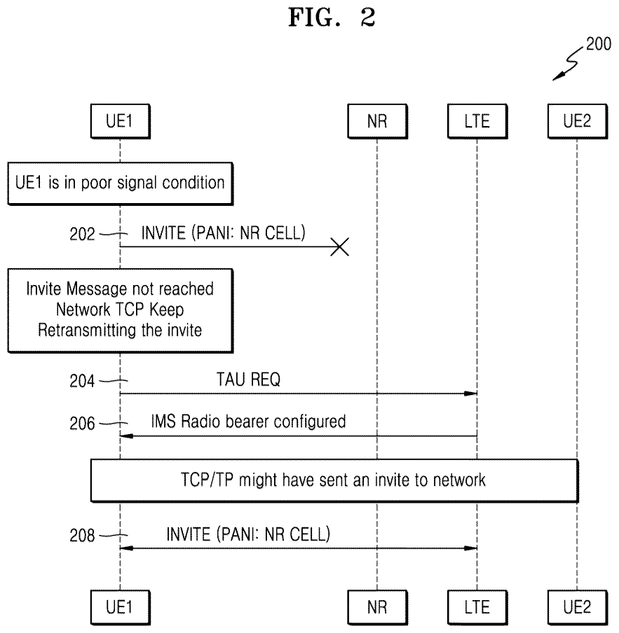

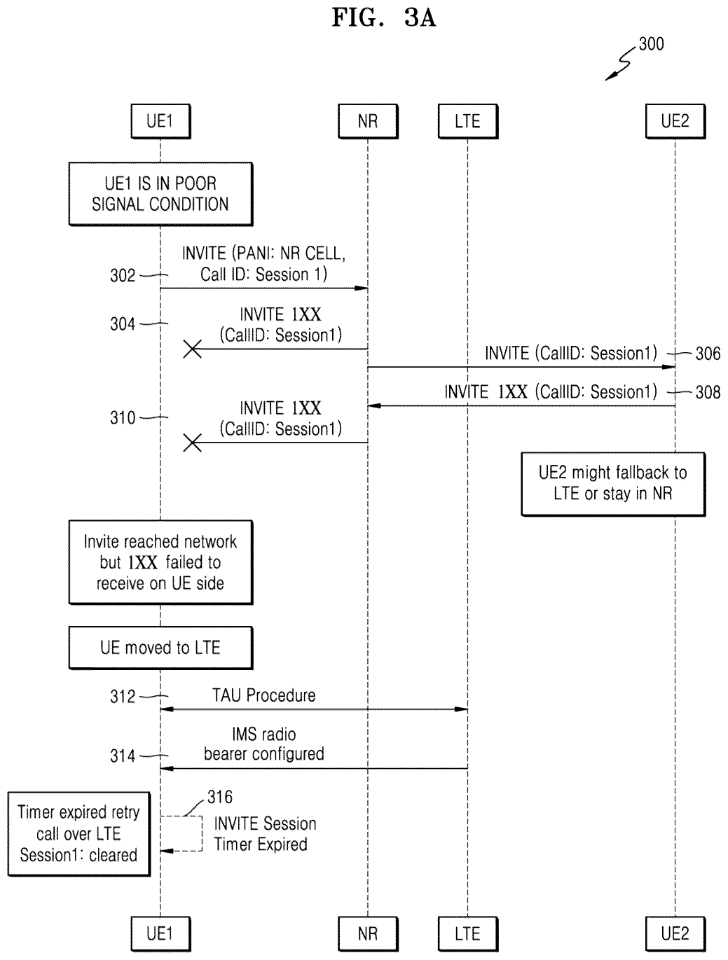

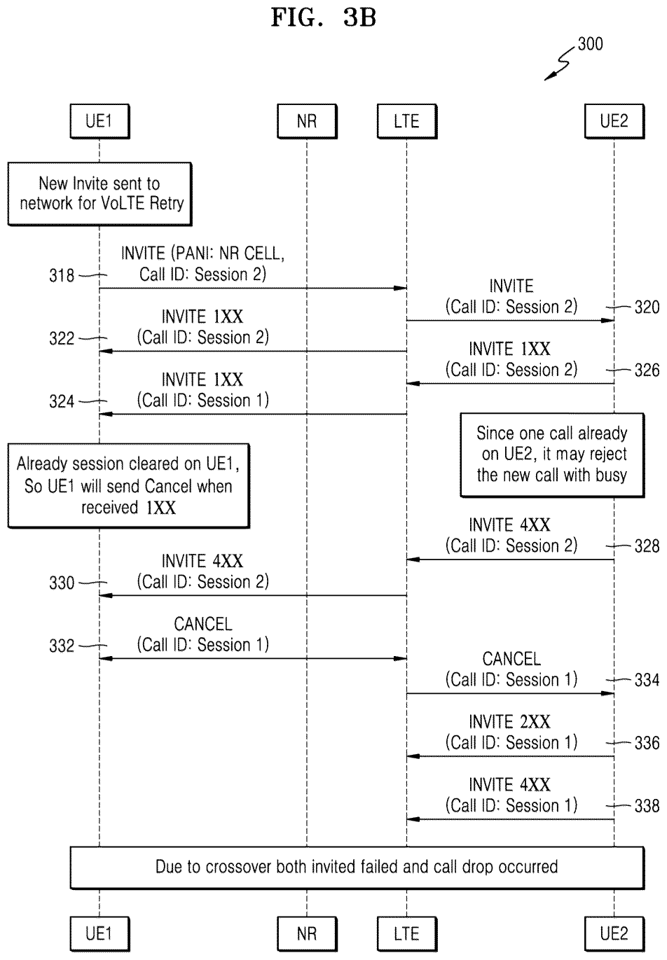

### DETAILED DESCRIPTION

For the purpose of promoting an understanding of the principles of the present disclosure, reference is made to the embodiments illustrated in the drawings and specific language may be used to describe the same. Nevertheless, it is to be understood that no limitation of the scope of the present disclosure is thereby intended, such alterations and further modifications in the illustrated system, and such further applications of the principles of the present disclosure as illustrated therein being contemplated as would normally occur to one skilled in the art to which the disclosure relates.

It is to be understood by those skilled in the art that the foregoing general description and the following detailed description are explanatory of the present disclosure and are not intended to be restrictive thereof.

Further, skilled artisans are to appreciate that elements in the drawings are illustrated for simplicity and may not have been necessarily drawn to scale. For example, the flow charts illustrate a method in terms of the most prominent operations involved to help to improve understanding of aspects of the present disclosure. Furthermore, in terms of the construction of a system, one or more components of the system may have been represented in the drawings by conventional symbols, and the drawings may show only those specific details that are pertinent to understanding the embodiments of the present disclosure so as not to obscure the drawings with details that may be readily apparent to those of ordinary skill in the art having the benefit of the description herein.

With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

Reference throughout this disclosure to “an aspect”, “another aspect” or similar language may indicate that a particular feature, structure, or characteristic described in connection with the embodiment is included in at least an embodiment of the present disclosure. Thus, appearances of the phrase “in an embodiment”, “in another embodiment”, and similar language throughout this disclosure may, but do not necessarily, all refer to the same embodiment.

The terms “comprise”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques may be omitted so as to not unnecessarily obscure the embodiments herein. Also, the various embodiments described herein are not necessarily mutually exclusive, as some embodiments may be combined with one or more other embodiments to form new embodiments. The term “or” as used herein, may refer to a non-exclusive or unless otherwise indicated. The examples used herein are intended merely to facilitate an understanding of ways in which the embodiments herein may be practiced and to further enable those skilled in the art to practice the embodiments herein. Accordingly, the examples should not be construed as limiting the scope of the embodiments herein.

It is to be understood that the specific order or hierarchy of blocks in the processes/flowcharts disclosed are an illustration of example approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

As is traditional in the field, embodiments may be described and illustrated in terms of blocks that carry out a described function or functions. These blocks, which may be referred to herein as units or modules or the like, may be physically implemented by analog or digital circuits, such as, but not limited to, logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports, such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the present disclosure. Likewise, the blocks of the embodiments may be physically combined into more complex blocks without departing from the scope of the present disclosure.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

The accompanying drawings are used to help easily understand various technical features and it may be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, or the like may be used herein to describe various elements, these elements may not be limited by these terms. These terms are generally only used to distinguish one element from another.

It should be noted that the terms “mobile originating (MO) device”, “first user equipment (UE)”, and “UE1” have been used interchangeably throughout the disclosure and the drawings. Further, the terms “mobile terminating (MT) device”, “second UE”, and “UE2” have been used interchangeably throughout the disclosure and the drawings.

It should be noted that even though the various embodiments of the present disclosure have been explained in respect of Long-Term Evolution (LTE) and New Radio (NR) wireless networks, the techniques of the present disclosure are also applicable to other communication standards such as, but not limited to, sixth generation (6G) communication systems or the like.

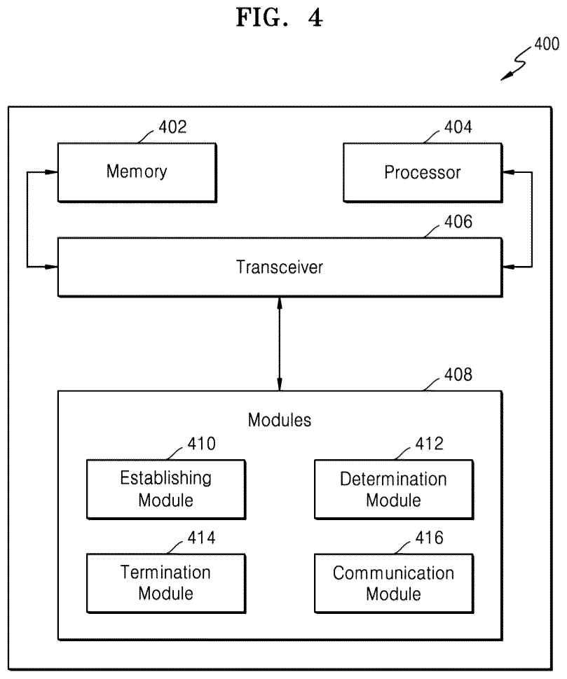

Referring now to the drawings, and more particularly to FIGS. 4 to 9, where similar reference characters denote corresponding features consistently throughout the figures, various embodiments of the present disclosure are described.

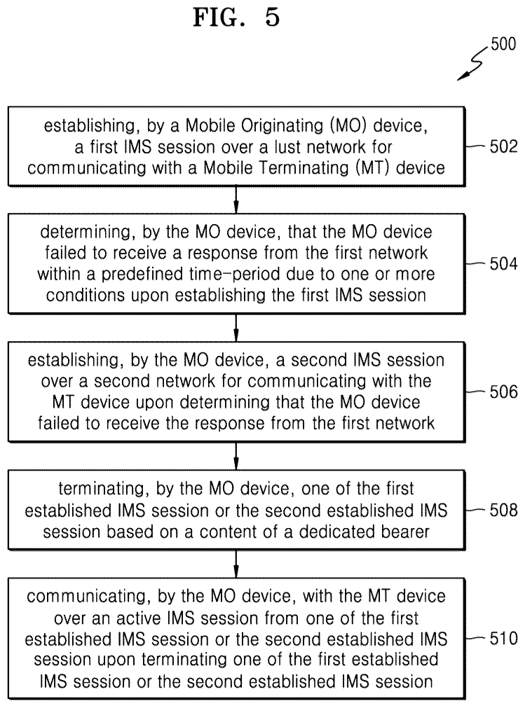

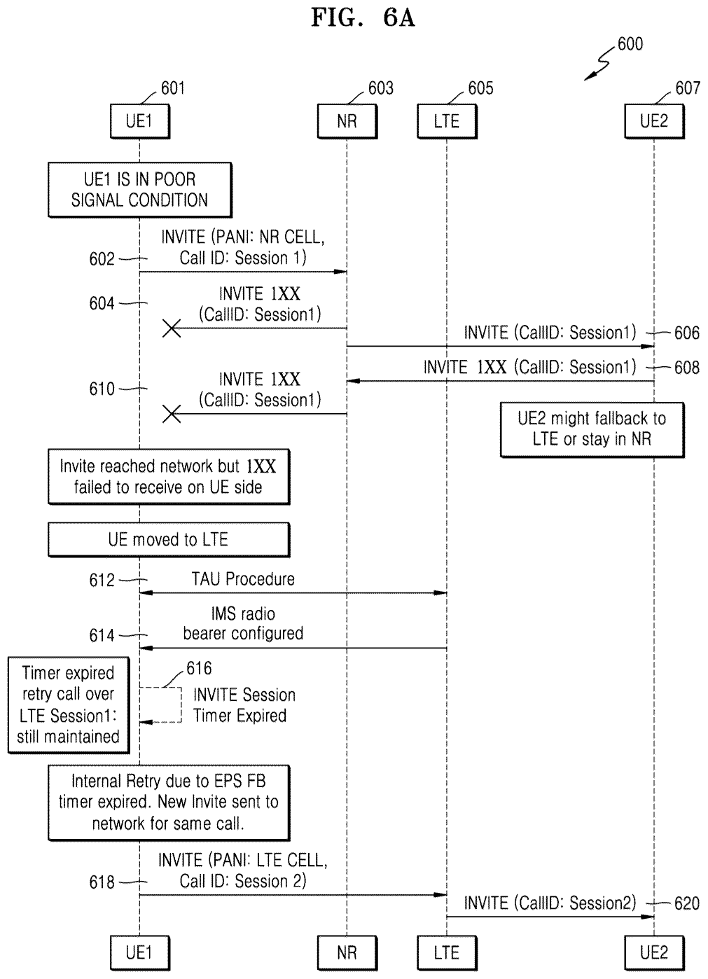

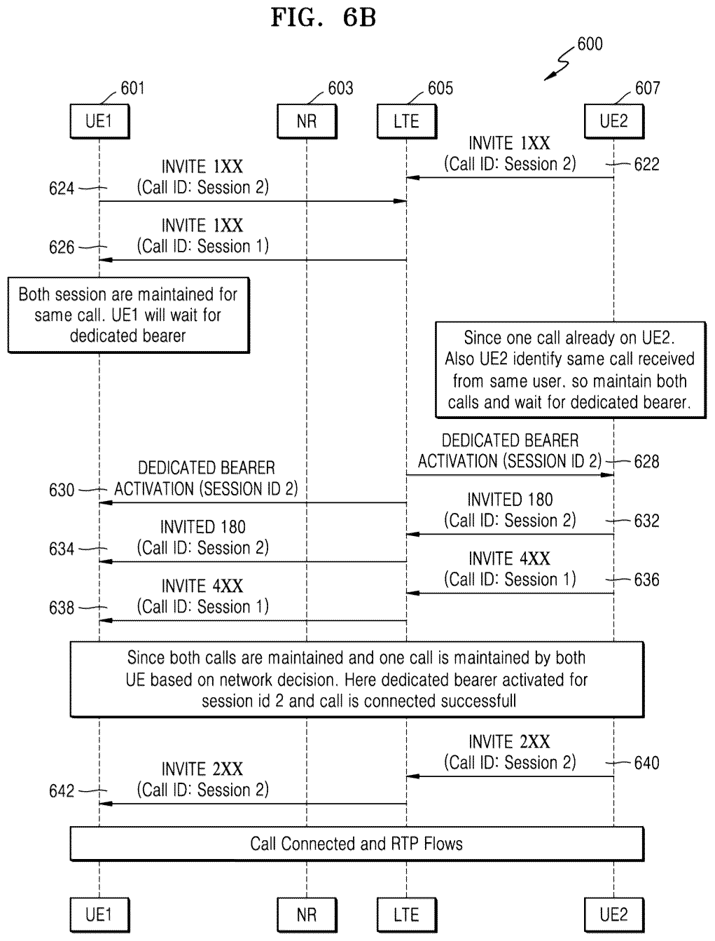

FIG. 4 illustrates a block diagram of a system 400 for establishing Internet protocol (IP) multimedia subsystem (IMS) sessions by a MO device, according to an embodiment. FIG. 5 illustrates a method 500 for IMS sessions by the MO device, according to an embodiment. FIGS. 6A and 6B illustrate a signal flow diagram 600 for establishing IMS sessions by the MO device, according to an embodiment. For the sake of brevity, FIGS. 4, 5, 6A, and 6B are explained in conjunction with each other.

In an embodiment, the system 400 may include a memory 402, a processor 404, a transceiver 406, and modules 408.

In an embodiment, the memory 402 may store information and/or data related to establishing IMS sessions, such as, but not limited to, content of a dedicated bearer, information related to first and/or second IMS sessions, or the like. Further, the memory 402 may store instructions to be executed by the processor 404 for establishing the IMS sessions by a MO device, as discussed throughout the disclosure. The memory 402 may be and/or may include non-volatile storage elements. Examples of such non-volatile storage elements may include, but not be limited to, magnetic hard discs, optical discs, floppy discs, flash memories, forms of electrically programmable memories (EPROM), forms of electrically erasable and programmable (EEPROM) memories, or the like. In addition, the memory 402 may, in some examples, be considered a non-transitory storage medium configured to store instructions and/or data to be executed by one or more processors (e.g., processor 404) to perform one or more functions and/or methods, as discussed throughout the present disclosure. The term “non-transitory” may indicate that the storage medium is not embodied in a carrier wave or a propagated signal. However, the term “non-transitory” should not be interpreted to indicate that the memory 402 is non-movable. In certain examples, a non-transitory storage medium may store data that may, over time, change (e.g., in random access memory (RAM), cache, or the like). The memory 402 may be and/or may include an internal storage unit, and/or the memory 402 may be and/or may include an external storage unit of a user device, a cloud storage, or any other type of external storage.

The processor 404 may communicate with the memory 402, the transceiver 406, and the modules 408. The processor 404 may be configured to execute instructions stored in the memory 402 and to perform various processes to establish the IMS sessions by the MO device, as discussed throughout the disclosure. The processor 404 may include one processor or a plurality of processors, which may include, but not be limited to, a general purpose processor (e.g., a central processing unit (CPU), an application processor (AP), or the like), a graphics-only processing unit (e.g., a graphics processing unit (GPU), a visual processing unit (VPU), or the like), and/or an artificial intelligence (AI) dedicated processor (e.g., a neural processing unit (NPU) or the like).

The transceiver 406 may be configured to communicate internally between internal hardware components and/or with external devices (e.g., server, another user device) via one or more networks (e.g., radio technology). The transceiver 406 may be and/or may include an electronic circuit specific to at least one standard that may enable wired and/or wireless communication. In an embodiment, the transceiver may be used to communicate with a MT device and/or a network connected with the MO device.

The modules 408 may be implemented by processing circuitry, such as, but not limited to, logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports, such as printed circuit boards or the like.

In an embodiment, the modules 408 may include an establishing module 410, a determination module 412, a termination module 414, and a communication module 416, which collectively may be referred to as one or more modules 410 to 416. The one or more modules 410 to 416 in conjunction with the processor 404 may perform one or more functions and/or methods as discussed with reference to FIGS. 5, 6A, and 6B, as discussed throughout the present disclosure. Alternatively or additionally, the one or more modules 410 to 416 may be implemented as digital circuits, and may be incorporated into the processor 404. For example, a field programmable gate array (FPGA) may be used to implement custom logic that includes functionality of the one or more modules 410 to 416.

In an embodiment, the system 400 may be a part of a MO device. In another embodiment, the system 400 may be connected to the MO device. In another embodiment, the system 400 may be hosted on a server. In such an embodiment, the MO device may access the system 400 hosted on the server to establish the IMS sessions. Examples of the MO device and/or the MT device may include, but are not limited to, a smartphone, a tablet computer, a personal digital assistance (PDA), an Internet of Things (IoT) device, a wearable device, or any other device capable of communicating with the network.

In an example embodiment, as shown in FIGS. 6A and 6B, the MO device (e.g., a first UE UE1 601) may be connected to a first network (e.g., an NR network 603) and may be attempting to establish an IMS session with the MT device (e.g., the second UE UE2 607). Referring to FIG. 5, at operation 502, the method 500 may include establishing a first IMS session over a first network for communicating with the MT device 607. In an embodiment, the first IMS session may include a video call, voice call, text message, or the like. In an embodiment, the establishing module 410 may transmit a first invite to the first network for establishing the first IMS session with the MT device 607. For example, the establishing module 410 may transmit the first invite to NR network 603 for establishing the first IMS session with the second UE UE2 607.

In an embodiment, the first invite may include a session identifier (ID) corresponding to the first IMS session. In another embodiment, the first invite may include a call ID. In an embodiment, the establishing module 410 may transmit the first invite by using the transceiver 406 and/or the communication module 416. The establishing module 410 may then establish the first IMS session over the first network for communicating with the MT device 607 based on the transmitted first invite.

Operation 502 is further explained with reference to FIG. 6A. As shown in FIG. 6A, at operation 602, the UE1 601 may transmit the first invite (e.g., INVITE (PANI: NR CELL, CallID session 1)) to the NR network 603. At operation 604, the NR network 603 may attempt to transmit the first invite response (e.g., INVITE 1XX (CallID session 1)) to the UE1 601, however, the NR network 603 may fail to transmit the first invite response. For example, the first invite response may fail to arrive and/or the UE1 601 may fail to receive the first invite response. At operation 606, the NR network 603 may transmit the received first invite to the UE2 607. At operation 608, the UE2 607 may transmit the first invite response to the NR network 603. At operation 610, the NR network 603 may again attempt to transmit the first invite response to the UE1 601, however, the NR network 603 may fail to transmit the first invite response to the UE1 601. For example, the first invite response may fail to arrive and/or the UE1 601 may fail to receive the first invite response. Further, the UE2 607 may fall back to the LTE network 605 and/or may stay connected to the NR network 603. That is, the first invite response may have reached the NR network 603 (e.g., NR), however, the first invite response may not have been received by the UE1 601. Consequently, the UE1 601 may attempt to move to the LTE network 605. Accordingly, at operation 612, a tracking area update (TAU) procedure may be interchangeably shared between the UE1 601 and the LTE network 605. At operation 614, the LTE network 605 may transmit a configured IMS dedicated bearer to the UE1 601. In an embodiment, the configured IMS dedicated bearer may include traffic flow template (TFT), quality of service (QoS) information, and the like. At operation 616, the predefined time-period may expire for checking whether the UE1 601 has received the first invite response. In an embodiment, the predefined timed-period may be predefined by the MO device 601. For example, the predefined time-period may be about four (4) to six (6) seconds. In another embodiment, the predefined timed-period may be predefined by the first network (e.g., the NR network 603).

Accordingly, at operation 504, the determination module 412 may determine that the MO device 601 failed to receive a response from the first network within a predefined time-period due to one or more conditions upon establishing the first IMS session. In an embodiment, the one or more conditions may include poor signal condition of the first network. For example, the determination module 412 may determine a poor signal condition of the first network based on at least one signal condition of the first network failing to meet a predetermined threshold. In an embodiment, unlike a related MO device, after the expiry of the predefined time-period, the UE1 601 may not clear the first invite, which may have been initiated over the NR network 603.

Accordingly, at operation 506 of FIG. 5, the method 500 may include establishing a second IMS session over a second network (e.g., the LTE network 605) for communicating with the MT device 607 upon determining that the MO device 601 failed to receive the response from the first network (e.g., the NR network 603). In an embodiment, the second IMS session may be and/or may include a video call, a voice call, a text message, or the like. In particular, the establishing module 410 may establish the second IMS session over the second network (e.g., the LTE network 605) with the MT device 607. In an embodiment, the establishing module 410 may transmit a second invite to the second network for establishing the second IMS session with the MT device upon determining that the MO device 601 failed to receive the response from the first network. For example, the establishing module 410 may transmit the second invite to the LTE network 605 for establishing the second IMS session with MT device 607. In an embodiment, the second invite may include a session ID corresponding to the second IMS session. In another embodiment, the second invite may include the CallID. In an embodiment, the second invite may also include information about the second network. In an embodiment, the establishing module 410 may transmit the second invite by using the transceiver 406 and/or the communication module 416. The establishing module 410 may establish the second IMS session over the second network for communicating with the MT device 607 based on the transmitted second invite.

Operation 506 is further explained with reference to FIGS. 6A and 6B. Referring back to FIGS. 6A and 6B, at operation 618, the UE1 601 may transmit a second invite (e.g., INVITE (PANI: NR CELL, CallID session 2)) to the second network (e.g., the LTE network 605). At operation 620, the LTE network 605 may forward the second invite to UE2 607. At operation 622, the UE2 607 may transmit a second invite response (e.g., INVITE 1XX (CallID session 2)) to the LTE network 605, which may be forwarded to the UE1 601 along with the first invite response at operations 624 and 626. Accordingly, both the first IMS session and the second IMS session may be maintained at the UE1 601 for the same call, while the UE1 601 waits for a dedicated bearer. Since the UE2 607 may have already received the first invite from the UE1 601, the UE2 607 may determine that the second invite has also been received from the UE1 601. Accordingly, both the IMS sessions may be maintained at the UE2 607, while the UE2 607 waits for the dedicated bearer.

Referring back to FIG. 5, at operation 508, the method 500 may include terminating one of the first IMS session or the second established IMS session based on a content of the dedicated bearer. In an embodiment, the content of the dedicated bearer may include, but not be limited to, TFT, QoS parameters, or the like, as defined by 3rd Generation Partnership Project (3GPP™) technical specifications (e.g., 3GPP TS 23.401 Release 8, or 3GPP TS 24.501 Release 15) for 3GPP access networks. In an embodiment, the content of the dedicated bearer may relate to both NodeB (e.g., NR) and to core network (e.g., LTE). In an embodiment, the termination module 414 may obtain the content of the dedicated bearer by monitoring a dedicated bearer activation. The termination module 414 may terminate one of the first established IMS session or the second established IMS session based on the content of the dedicated bearer.

Operation 508 is further explained with reference to FIG. 6B. Referring back to FIG. 6B, at operation 628, the dedicated bearer may be activated and may be sent from the LTE network 605 to the UE2 607 corresponding to the second IMS session. At operation 630, the LTE network 605 may transmit the dedicated bearer to the UE1 601 corresponding to the second IMS session. At operation 632, the UE2 607 may transmit an invite 180 corresponding to the second IMS session (e.g., INVITE 180 (CallID: Session 1)) to the LTE network 605. In an embodiment, the invite 180 may confirm that the second IMS session has to be continued. In an embodiment, the UE2 607 may determine that the second IMS session has to be continued based on the content of the dedicated bearer. At operation 634, the LTE network 605 may forward the invite 180 to the UE1 601. At operation 636, the UE2 607 may transmit a 4xx invite corresponding to the first IMS session (e.g., INVITE 4XX (CallID: Session 1)) to the LTE network 605. In an embodiment, the 4XX invite may confirm that the first IMS session has to be terminated. In an embodiment, the UE2 607 may determine that the first IMS session has to be terminated based on the content of the dedicated bearer. At operation 638, the LTE network 605 may share the 4xx invite with the UE1 601. Accordingly, the UE1 601 may terminate the first IMS session. Hence, one IMS session may be maintained by both the UE1 601 and the UE2 607 based on the dedicated bearer provided by the LTE network 605. However, the present disclosure is not limited in this regard. For example, the second IMS session may be terminated and the first IMS session may be maintained.

Referring back to FIG. 5, at operation 510, the method 500 may include communicating with the MT device 607 over an active IMS session from one of the first established IMS session or the second established IMS session upon terminating one of the first established IMS session or the second established IMS session. In continuation of the above example, the UE1 601 may communicate with UE2 607 over the second IMS session.

Operation 510 is further explained with reference to FIG. 6B. Referring back to FIG. 6B, at operation 640, a second invite response corresponding to the second IMS session (e.g., INVITE 2XX (CallID: Session 2)) may be transmitted from the UE2 607 to the LTE network 605. At operation 642, the second invite response may be transmitted from the LTE network 605 to the UE1 601. Thus, the second IMS session may be successfully established between the MO device (e.g., the UE1 601) and the MT device (e.g., the UE2 607). Hence, both the MO device (e.g., the UE1 601) and the MT device (e.g., the UE2 607) may monitor the dedicated bearer activation closely and determine which session to drop and which to continue (maintain) based on the content of the dedicated bearer.

Although the above description may focus on an example of a handover from an NR network to an LTE network, the present disclosure is not limited in this regard. For example, the techniques of the present disclosure may also be applicable in a reverse scenario (e.g., handover from an LTE network to an NR network). Accordingly, in an embodiment, the first network may be a New Radio (NR) network or a Long-Term Evolution (LTE) network. However, in another embodiment, the second network may the NR network or the LTE network. Further, the techniques of the present disclosure are also applicable in communication standards other than NR and LTE, such as, but not limited to, fifth generation (5G), 5G Advanced, 6G, beyond 6G, or the like.

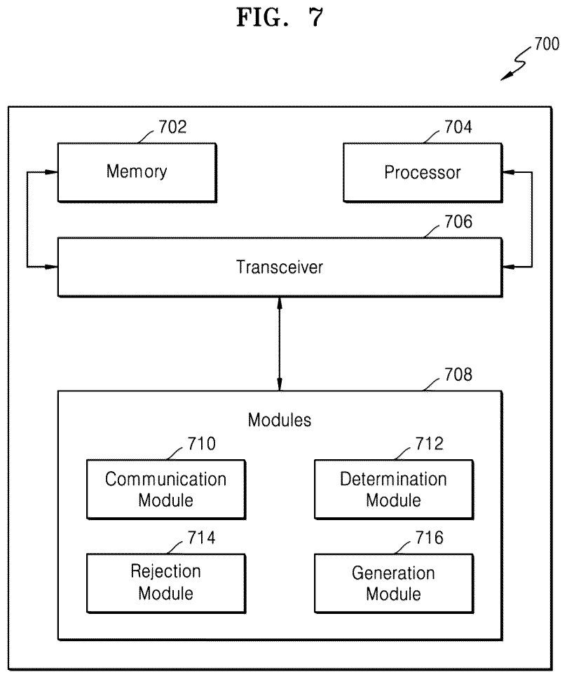

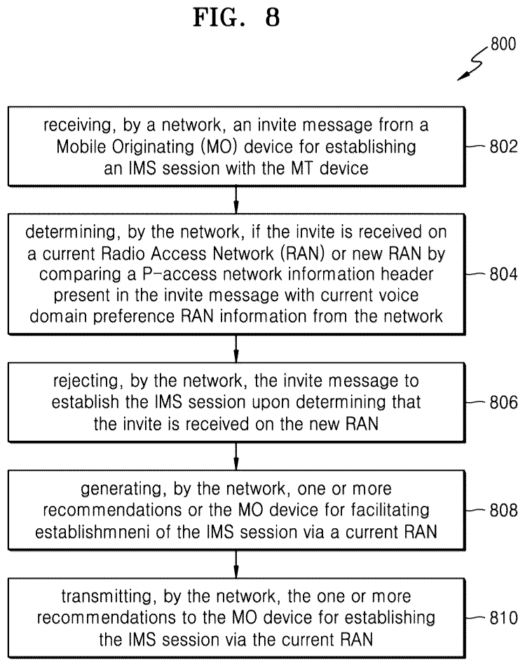

FIG. 7 illustrates a block diagram of a system for IMS sessions by a network (e.g., a network device), according to an embodiment. FIG. 8 illustrates a method for establishing IMS sessions by a network (e.g., a network device), according to an embodiment. For the sake of brevity, FIGS. 7 and 8 are explained in conjunction with each other.

In an embodiment, the system 700 may include a memory 702, a processor 704, a transceiver 706, and modules 708.

In an embodiment, the memory 702 may store information and/or data related to establishing IMS sessions, such as, but not limited to, invite message, one or more recommendations, information related to first and/or second IMS sessions, or the like. Further, the memory 702 may store instructions to be executed by the processor 704 for establishing the IMS sessions by the network, as discussed throughout the disclosure. The memory 702 may be and/or may include non-volatile storage elements. Examples of such non-volatile storage elements may include, but not be limited to, magnetic hard discs, optical discs, floppy discs, flash memories, forms of EPROM, forms of EEPROM, or the like. In addition, the memory 702 may, in some examples, be considered a non-transitory storage medium configured to store instructions and/or data to be executed by one or more processors (e.g., processor 704) to perform one or more functions and/or methods, as discussed throughout the present disclosure. The term “non-transitory” may indicate that the storage medium is not embodied in a carrier wave or a propagated signal. However, the term “non-transitory” may not be interpreted to indicate that the memory 702 is non-movable. In certain examples, a non-transitory storage medium may store data that may, over time, change (e.g., in RAM, cache, or the like). The memory 702 may be and/or may include an internal storage unit, and/or the memory 702 may be and/or may include an external storage unit of a user device, a cloud storage, or any other type of external storage.

The processor 704 may communicate with the memory 702, the transceiver 706, and the modules 708. The processor 704 may be configured to execute instructions stored in the memory 702 and to perform various processes to establish the IMS sessions by the network, as discussed throughout the disclosure. The processor 704 may include one processor or a plurality of processors, which may include, but not be limited to, a general purpose processor (e.g., a CPU, an AP, or the like), a graphics-only processing unit (e.g., a GPU, a VPU, or the like), and/or an AI dedicated processor (e.g., an NPU, or the like).

The transceiver 706 may be configured to communicate internally between internal hardware components and/or with external devices (e.g., server, another user device) via one or more networks (e.g., radio technology). The transceiver 706 may be and/or may include an electronic circuit specific to at least one standard that may enable wired and/or wireless communication. In an embodiment, the transceiver may be used to communicate with the MT device (e.g., the UE2 607) and/or the MO device (e.g., the UE1 601).

The modules 708 may be implemented by processing circuitry, such, but not limited to, as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports, such as printed circuit boards or the like.

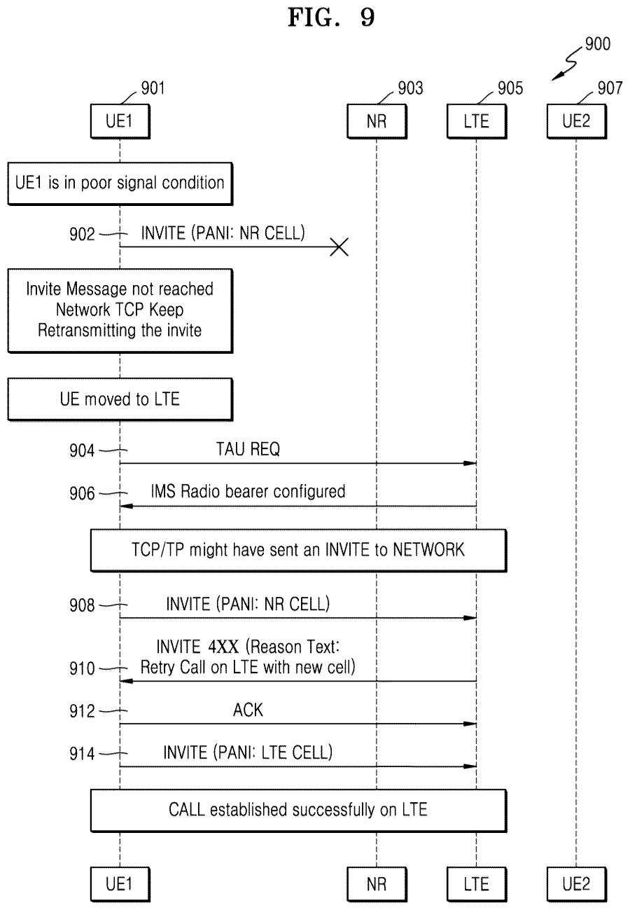

In an embodiment, the modules 708 may include a communication module 710, a determination module 712, a rejection module 714, and a generation module 716, which collectively may be referred to as one or more modules 710 to 716. The one or more modules 710 to 716 in conjunction with the processor 704 may perform one or more functions and/or methods as discussed with reference to FIGS. 8 and 9, as discussed throughout the present disclosure. Alternatively or additionally, the one or more modules 710 to 716 may be implemented as digital circuits, and may be incorporated into the processor 704. For example, an FPGA may be used to implement custom logic that includes functionality of the one or more modules 710 to 716.

In an embodiment, the system 700 may be a part of a network architecture. In another embodiment, the system 700 may be connected to the network. In another embodiment, the system 700 may be hosted on a server. In such an embodiment, the network may access the system 700 hosted on the server to establish the IMS sessions.

Referring now to FIG. 8, at operation 802, the method 800 may include receiving an invite message from the MO device (e.g., the UE1 601) for establishing an IMS session with the MT device (e.g., the UE2 607). In an embodiment, the invite message may correspond to and/or may include a session initiation protocol (SIP) invite message. For example, the communication module 710 may receive the first invite and/or the second invite.

At operation 804, the method 800 may include determining if the invite is received on a current radio access network (RAN) or a new RAN by comparing a P-access network information header present in the invite message with current voice domain preference RAN information from the network. For example, with reference to FIG. 6, the determination module 712 may determine if the invite is received on the current RAN through which the MO device 601 is connected with the network, such as the NR network 603. The determination module 712 may further determine if the invite is received on the new RAN such as the LTE network 605 by comparing a P-access network information header present in the invite message with current voice domain preference RAN information from the network. In an example embodiment, the network may store radio access technology (RAT) information of the UE where the UE gets connected. Similarly, the network may derive the RAT information from P-Access network info. Accordingly, the comparison of the P-access network information header with current voice domain preference RAN information may be performed relatively easily on the network side.

At operation 806, the method 800 may include rejecting the invite message to establish the IMS session upon determining that the invite is received on the new RAN. In particular, with reference to FIGS. 6A and 6B, if the invite is received on the LTE network 605, then the rejection module 714 may reject the invite message to establish the IMS session. At operation 808, the method 800 may include generating one or more recommendations for the MO device 601 for facilitating establishment of the IMS session via the current RAN. For example, the generation module 716 may generate the one or more recommendations to establish the IMS session between the MO device 601 and the MT device 607 via the NR network 603. In an embodiment, the one or more recommendations may include a recommendation in which the network may reply with error response by providing new cause value which may indicate about retry on other RAT.

At operation 810, the method 800 may include transmitting the one or more recommendations to the MO device (e.g., the UE1 601) for establishing the IMS session via the current RAN. For example, the communication module 710 may transmit the one or more recommendations to the MO device (e.g., the UE1 601) to establish the IMS session between the MO device (e.g., the UE1 601) and the MT device (e.g., the UE2 607) via the NR network 603.

FIG. 9 illustrates a signal flow diagram for establishing IMS sessions, according to an embodiment. At operation 902, a first UE UE1 901 may attempt to transmit an invite message (e.g., INVITE (PANI: NR CELL)) for initiating an IMS session, with a second UE UE2 907 to a first network (e.g., NR network 903). However, the invite message may not reach the NR network 903 and the TCP layer of the first UE UE1 901 may continue retransmitting the invite message. Further, the first UE UE1 901 may attempt to move to a second network (e.g., a LTE network 905).

At operation 904, a TAU REQ may be shared from the first UE UE1 901 to the LTE network 905. At operation 906, the LTE network 905 may transmit a configured IMS radio bearer to the first UE UE1 901. Further, the TCP/IP layer of the first UE UE1 901 may also send the invite message to the LTE network 905. Accordingly, at operation 908, the invite message may be transmitted from the first UE UE1 901 to the LTE network 905, wherein the invite message may contain information related to an NR cell. Hence, at operation 910, a 4xx invite may be transmitted from the LTE network 905 to the first UE UE1 901 with a reason text: retry call on LTE with LTE cell information.

At operation 912, an ACK may be transmitted from the first UE UE1 901 to the LTE network 905. At operation 914, the invite message for the LTE cell may be transmitted to the LTE network 905 containing information related to the LTE cell, which may successfully establish the IMS session on the LTE network 905.

Aspects of the present disclosure may provide for potentially reducing and/or avoiding call setup fail and/or drop issues when the UE supports the NR network 903 and is attached to the NR cell. Further, additional aspects of the present disclosure may provide for potentially reducing and/or avoiding collision cases that may occur due to retry procedures when establishing IMS sessions, which may result in improving key performance parameters (KPI) of the VoNR.

Unless otherwise indicated, all technical and scientific terms used herein may have the same meaning as commonly understood by one of ordinary skill in the art to which the present disclosure belongs. The system, methods, and examples provided herein are illustrative only and are not intended to be limiting.

Benefits, other advantages, and solutions to problems have been described above with regard to specific embodiments. However, the benefits, advantages, solutions to problems, and any components that may cause any benefit, advantage, or solution to occur or become more pronounced are not to be construed as a critical, required, or essential feature or component of any or all the claims.

While specific language has been used to describe the present subject matter, any limitations arising on account thereto, are not intended. As would be apparent to a person skilled in the art, various working modifications may be made to the methods in order to implement the present disclosure as taught herein. The drawings and the foregoing description give examples of embodiments. Those skilled in the art may appreciate that one or more of the described elements may well be combined into a single functional element. Alternatively, certain elements may be split into multiple functional elements. Elements from one embodiment may be added to another embodiment.

What is claimed is:

1. A method of establishing Internet protocol (IP) multimedia subsystem (IMS) sessions at a mobile originating (MO) device, the method comprising:
establishing, with a mobile terminating (MT) device, a first IMS session over a first network, the first IMS session being configured to perform first communications between the MO device and the MT device;
determining that the MO device failed to receive a response from the first network within a predefined time period after the establishing of the first IMS session;
establishing, with the MT device, a second IMS session over a second network, based on the determining that the MO device failed to receive the response from the first network, the second IMS session being configured to perform second communications between the MO device and the MT device;
terminating, based on a content of a dedicated bearer, at least one of the first IMS session or the second IMS session; and
communicating with the MT device over a remaining IMS session from the at least one of the first IMS session or the second IMS session.

2. The method of claim 1, wherein the first network is one of a New Radio (NR) network or a Long-Term Evolution (LTE) network.

3. The method of claim 1, wherein the second network is one of a New Radio (NR) network or a Long-Term Evolution (LTE) network.

4. The method of claim 1, wherein the establishing the first IMS session comprises:
transmitting a first invite to the first network, the first invite requesting to establish the first IMS session with the MT device; and
establishing the first IMS session over the first network based on the first invite.

5. The method of claim 1, wherein the establishing the second IMS session comprises:
transmitting a second invite to the second network, the second invite requesting to establish the second IMS session with the MT device; and
establishing the second IMS session over the second network based on the second invite.

6. The method of claim 5, wherein the terminating the at least one of the first IMS session or the second IMS session comprises:
obtaining the content of the dedicated bearer by monitoring a dedicated bearer activation.

7. The method of claim 1, wherein the content of the dedicated bearer comprises at least one of a traffic flow template (TFT) or quality of service (QoS) information.

8. The method of claim 1, wherein the determining that the MO device failed to receive the response from the first network comprises:
determining that the MO device failed to receive the response from the first network due to one or more conditions comprising a signal condition of the first network failing to meet a predetermined threshold.

9. The method of claim 1, wherein the terminating of the at least one of the first IMS session or the second IMS session comprises:
receiving, from the MT device, an invite response indicating a selected IMS session to maintain active from the at least one of the first IMS session or the second IMS session.

10. A method of establishing Internet protocol (IP) multimedia subsystem (IMS) sessions at a network device, the method comprising:
receiving, from a mobile originating (MO) device, an invite message requesting to establish an IMS session with a mobile terminating (MT) device;
determining whether the invite is received on a current radio access network (RAN) or a new RAN by comparing a P-access network information header of the invite message with current voice domain preference RAN information of the network device;
rejecting the invite message based on determining that the invite is received on the new RAN;
generating one or more recommendations for the MO device to establish the IMS session via the current RAN; and
transmitting, to the MO device, the one or more recommendations.

11. The method of claim 10, wherein the invite message comprises a session initiation protocol (SIP) invite message.

12. The method of claim 10, wherein the one or more recommendations comprise a recommendation to reply with an error message indicating to retry establishing the IMS session on another radio access technology (RAT).

13. A system for establishing Internet protocol (IP) multimedia subsystem (IMS) sessions at a mobile originating (MO) device, the system comprising:
a memory storing instructions;
a transceiver; and
one or more processors communicatively coupled to the memory and the transceiver, wherein the one or more processors are configured to execute the instructions to:
establish a first IMS session over a first network, the first IMS session being configured to perform first communications between the MO device and a mobile terminating (MT) device;
determine that the MO device failed to receive a response from the first network within a predefined time-period after the establishing of the first IMS session;
establish a second IMS session over a second network based on the determining that the MO device failed to receive the response from the first network, the second IMS session being configured to perform second communications between the MO device and the MT device;
terminate at least one of the first IMS session or the second IMS session based on a content of a dedicated bearer; and
perform communications between the MO device and the MT device over a remaining IMS session from the at least one of the first IMS session or the second IMS session.

14. The system of claim 13, wherein the first network is one of a New Radio (NR) network or a Long-Term Evolution (LTE) network.

15. The system of claim 13, wherein the second network is one of a New Radio (NR) network or a Long-Term Evolution (LTE) network.

16. The system of claim 13, wherein the one or more processors are further configured to execute further instructions to:
transmit, via the transceiver, a first invite to the first network, the first invite requesting to establish the first IMS session with the MT device; and
establish the first IMS session over the first network based on the first invite.

17. The system of claim 13, wherein the one or more processors are further configured to execute further instructions to:
transmit a second invite to the second network, the second invite requesting to establish the second IMS session with the MT device; and
establish the second IMS session over the second network based on the second invite.

18. The system of claim 13, wherein the one or more processors are further configured to execute further instructions to:
obtain the content of the dedicated bearer by monitoring a dedicated bearer activation.

19. A system for establishing Internet protocol (IP) multimedia subsystem (IMS) sessions at a network device, the system comprising:
a memory storing instructions;
a transceiver; and
a one or more processors communicatively coupled to the memory and the transceiver, wherein the one or more processors are configured to execute the instructions to:
receive, from a mobile originating (MO) device via the transceiver, an invite message requesting to establish an IMS session with a mobile terminating (MT) device;
determine whether the invite is received on a current radio access network (RAN) or a new RAN by comparing a P-access network information header of the invite message with current voice domain preference RAN information of the network device;
reject the invite message based on a determination that the invite is received on the new RAN;
generate one or more recommendations for the MO device to establish the IMS session via the current RAN; and
transmit, to the MO device via the transceiver, the one or more recommendations.

20. The system of claim 19, wherein the invite message comprises a session initiation protocol (SIP) invite message.
